(19) United States
(12) Patent Application Publication
(10) Pub. No.: US 2004/0044797 A1
(43) Pub. Date: Mar. 4, 2004

(54) Device and method for filtering messages in a series-type communication system

(76) Inventors: Paul Kinowski, Aix-En-Provence (FR); Christophe Maitrejean, Cize (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 10/451,869

(22) PCT Filed: Dec. 26, 2000
(86) PCT No.: PCT/FR00/03687

(51) Int. Cl. G06F 15/16

(52) U.S. Cl. 709/250

(57) ABSTRACT

The invention relates to serial type telecommunications networks in which the messages are sent to all the nodes of the network and each comprise an identifier code indicating the content of the message.

The invention resides in a device and a method of filtering received messages so as to keep only the messages intended for the node concerned. The method consists of:

(a) establishing a list (48) of the identifier codes (ID) corresponding to messages susceptible of being processed by the microcontroller (32, MC), (b) allocating (50) to each identifier code (ID) of the list an index (FMI), (c) associating (44), to each message presenting an identifier code of the list, the index (FMI) which has been allocated thereto, (d) associating (66) to each index (FMI) an address in a memory (64), and (e) storing each message in the memory (64) at the address pointed by the index (FMI).

### FIELD OF THE INVENTION

The present invention relates to serial (series) type communications systems operating between different elements of a network, and more particularly, to a method and device for filtering in each of the elements messages sent over the network for keeping only those messages that relate to the element concerned.

### BACKGROUND OF THE INVENTION

An example application of serial type communications systems is in a motor vehicle, in which there are provided several networks. Each network is allocated to a different sub-group of the vehicle, such as the engine, the passenger compartment, lighting, diagnostics, etc.

In each sub-group, e.g., the passenger compartment 10 (FIG. 1), the elements or nodes, such as the sub-group's central computer 12, door 14, opening roof apparatus 16, passenger compartment thermometer 18, seat 20, and air conditioning apparatus 22 are interconnected by a multi-conductor cable 24. Messages supplied by the different elements or nodes of all the network nodes are sent over the multi-conductor cable 24.

However, the message sent does not indicate the identity of the receiver, but the type or content of the message. For instance, the temperature of the passenger compartment is associated with an identification code. The message further includes the corresponding data, such as the value of the temperature of the passenger compartment. This results in each node of the network receiving all the messages sent over the cable, which must then perform a sorting operation to keep only those that are of interest or are necessary for its operation.

To this end, each element or node 12 to 22 comprises a transmitter/receiver device (T/R) 30 connected to the cable or serial bus 24, a microcontroller (MC) 32 for managing the different functions of the node concerned, and a network controller (CAN) 34. The network controller (CAN) 34 acts as interface between the transmitter/receiver device 30 and the microcontroller 32 so as to present to the microcontroller only those messages that concern it.

There exist two main types of network controllers. One type is known as Full CAN and the other type is known as Basic CAN. In the Full CAN controller, there are as many buffers (known as mailboxes) as there are types of messages capable of being processed by the microcontroller 32. Each mailbox is allocated to a message type, and the microcontroller knows that allocation so that it can transfer the message in its memory as soon as it needs it.

In the Basic CAN controller, the number of mailboxes is less than the number that would be necessary with a Full CAN controller. In fact, these mailboxes are set up in the form of a FIFO (first in, first out) buffer memory. With such a memory, the microcontroller 32 does not know the identification of the messages contained therein because there is no allocation of a part of the buffer memory to each type of message.

Consequently, the microcontroller 32 must perform certain operations in software to identify received messages by comparing the identifier code or message identifier with a list of identifiers for messages capable of being processed by the microcontroller. In the case of a positive comparison, an index corresponding to that identifier indicates the address of the microcontroller's memory in which that message is to be stored for processing. The Basic CAN controller has the major drawback of frequently calling upon the microcontroller 32, i.e., interrupting it in its tasks related to the application concerned, to the detriment of its efficiency.

In contrast, the Full CAN controller reduces the microcontroller interruptions to a minimum, but requires the use of a number of mailboxes that is greater than the number of message types. This results in an increase of the area of silicon dedicated to mailboxes, which is to the detriment of the other circuits. Moreover, as the number of applications evolves, the number of mailboxes becomes insufficient to process new message types, unless a new controller with a sufficient number of mailboxes is developed, which is costly.

### SUMMARY OF THE INVENTION

An object of the present invention is to provide a device and to implement a method in each node of a serial type communications network, in which all the messages sent are received by all the nodes, for filtering through to the microcontroller of each node the messages intended for it. This is done while allowing a straightforward adaptation to an arbitrary number of messages to be filtered without a substantial modification in the size of the memories, and without a substantial increase in the number of microcontroller interruptions.

The present invention relates to a device for filtering messages received in a node of a serial type communications network in which the messages are sent to all the nodes of the network, and each message comprises an identifier code indicating the content of the message. The device is characterized by comprising means for associating an index to each identifier code from a list of identifier codes corresponding to messages susceptible of being processed by the microcontroller of the node, and means for associating to each message corresponding to an identifier code of the list an index associated to that identifier code. The device may further comprise means for storing in a FIFO type memory the message received and its associated index, and means for associating to each index an address in a memory so as to store each message received at a determined address in the memory.

The present invention also relates to a method of filtering messages received in a node of a serial type communications network in which the messages are sent to all the nodes of the network, and each message comprises an identifier code indicating the content of the message. The method may comprise the following steps: (a) establishing a list of the identifier codes corresponding to messages capable of being processed by the microcontroller of the node; (b) allocating to each identifier code of the list an index; (c) associating, to each message presenting an identifier code of the list, the index which has been allocated thereto; (d) associating to each index an address in a memory; and (e) storing each message in the memory at the address pointed by the index contained in the message.

### BRIEF DESCRIPTION OF THE DRAWINGS

Other characteristics and advantages of the present invention shall become apparent from reading the following description of a particular embodiment, the description being given in relation to the appended drawings in which:

FIG. 1 is a diagram of a serial type communications network or system connecting a plurality of elements or nodes to which the invention applies; and

FIG. 2 is a simplified block diagram of a message filtering device according to the present invention, illustrating also the method according to the present invention.

### DETAILED DESCRIPTION OF THE PREFERRED EMBODIMENTS

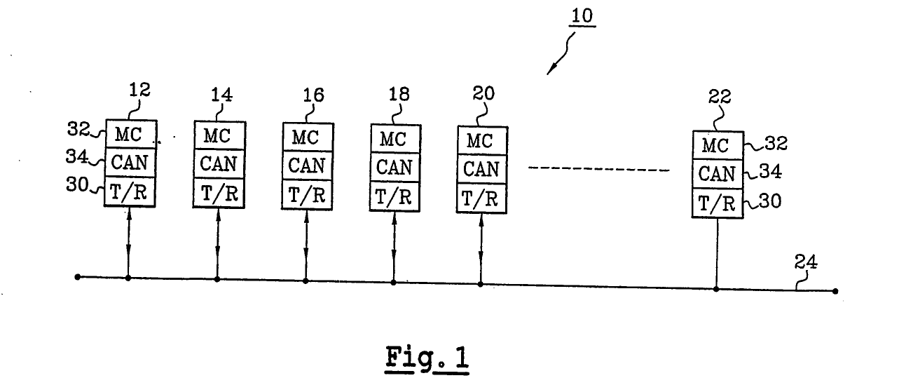

FIG. 1, already described above, is a diagram showing a serial type communications system or network in which a cable 24 interconnects a certain number of elements or nodes 12 to 22 to make them communicate by serial type binary messages, which are all received by each of the elements.

Each element or node 12 to 22 comprises a transmitter/receiver (T/R) 30 which sends and receives serial binary messages over the cable 24, and a microcontroller (MC) 32 which carries out the functions that are assigned to the element or node considered. In particular, some of the serial binary messages received by the transmitter/receiver 30 are executed.

Each element or node 12 to 22 further comprises a network controller (CAN) 34 which creates the bidirectional interface between the transmitter/receiver 30 and the microcontroller 32 by supplying to the transmitter/receiver the binary messages to send over the cable 24, and by submitting to the microcontroller only the binary messages that are intended for the latter.

More particularly, the network controller 34 comprises two parts. The first part is for analyzing and shaping the signals supplied by the transmitter/receiver 30 in accordance with the protocol. The second part is for filtering the messages shaped by the first part, and for submitting them to the microcontroller 32.

The invention pertains to the second part by providing a new device and a new method for filtering the received binary messages, and submitting them to the microcontroller 32 for the node. This new device and this new method call upon existing circuits and functions, but completes them with complementary circuits and operations.

The device and method according to the invention are implemented in the context of a Basic CAN type network controller. That is, the messages kept after filtering are stored in a FIFO type buffer memory 54.

There is associated to each message kept after filtering a number, designated an FMI number or index which defines the type of message among the N message types capable of being processed by the node's microcontroller 32. The kept message and the FMI number are stored in the FIFO memory. When this message is transferred to the microcontroller 32, the FMI number is used to interrogate a table which indicates the address in the volatile memory where that type of message is to be stored.

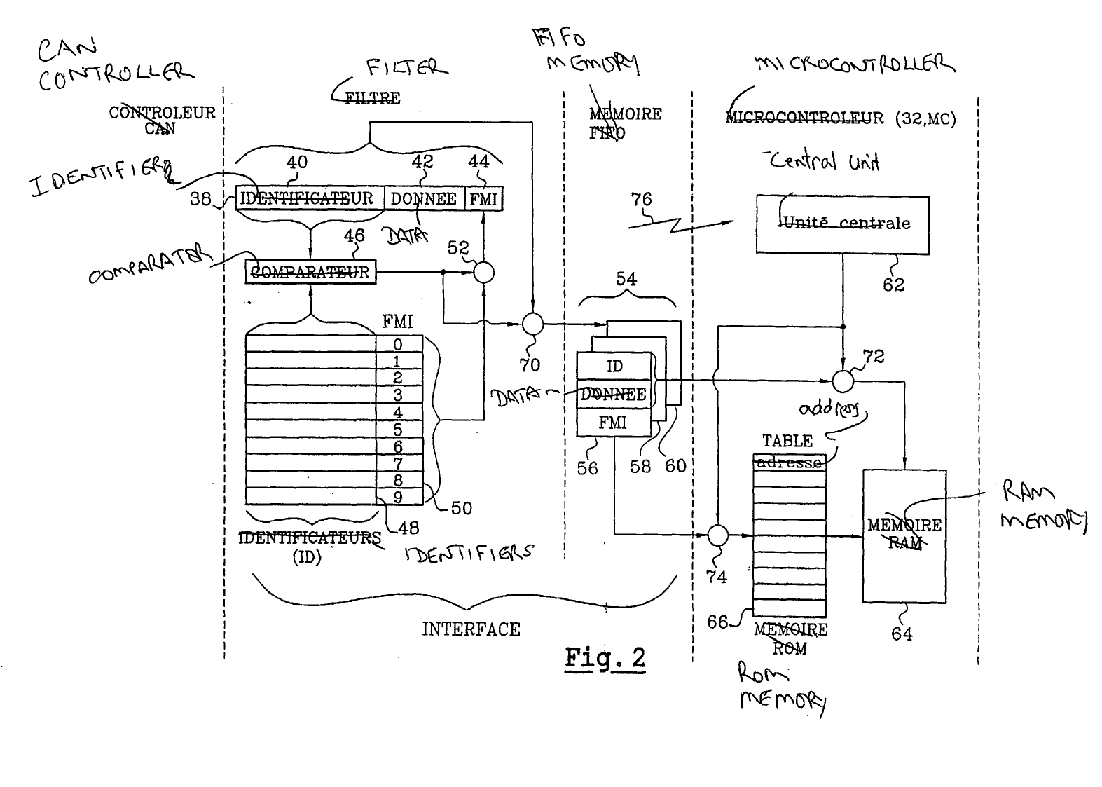

FIG. 2 is a diagram showing the circuits, as well as the operations, to be implemented to carry out the invention. The filtering of the messages is obtained by comparing in a comparator 46 the identifier code 40 (ID) of the received message with a list of identifier codes corresponding to messages capable of being processed by the node's microcontroller 32. The received message is stored in a register 38 and the list of identifier codes is stored in a series of registers 48, for example.

Each identifier code in the list is associated with an FMI number or index, for instance from 0 to 9 in the diagram. These numbers are stored in a series of registers 50. FMI is an acronym for Filter Match Index. The FMI number can be calculated by a procedure that is already known to obtain consecutive numbers.

When the comparison is positive, the corresponding FMI number is transferred to the part 44 of the register 38 via an electronic gate 52 whose opening is controlled by the comparator 46. This opening signal also commands the opening of another electronic gate 70 to transfer the received message and its associated FMI number into a FIFO type memory 54.

Naturally, the FMI number can be transferred directly to the buffer memory 54 without passing by the register 38, in which case the electronic gate 52 is arranged in parallel with respect to the electronic gate 70 that transfers the identifier code 40 and the data 42. The FIFO memory 54 comprises, for instance, three memory planes 56, 58 and 60. Each memory plane stores a received message. The received message is first stored in memory plane 60, and then transferred successively to memory planes 58 and 56.

The transfer from memory plane 56 to the microcontroller 32 (MC) is carried out in accordance with a traditional interruption procedure 76. This transfer is carried out by the microcontroller's central unit 62 by a signal which opens electronic gate 72 for the identifier and the data, and electronic gate 74 for the FMI index.

In the microcontroller 32 (MC), a ROM memory type correspondence table 66 enables association, with each FMI number, an address in a RAM type memory 64 in which the received message is to be stored. For instance, the address supplied by that table is the one where the first byte of the message is to be recorded. For the following FMI number, the address supplied shall be the one that follows the last byte of the message corresponding to the preceding FMI number. This results from the fact that to each identifier code there corresponds a well-defined message length having a determined number of bytes, for example.

The filtering device according to the invention comprises means 50 for associating an FMI number or FMI index to each identifier code ID in a list 48 of identifier codes corresponding to messages capable of being processed by the microcontroller 32, and means 44, 52 for associating to each message corresponding to an identifier code in the list with the FMI index associated to that identifier code. The device further comprises means 70 for storing in a FIFO type memory 54 the received message and its associated FMI index, and means 66 for associating to each FMI index an address in the memory 64 so as to register each message received at a determined address in the memory 64.

The device described above in relation to FIG. 2 and its operating mode allows a filtering method according to the invention to be defined which comprises the following steps:

(a) establishing a list 48 of identifier codes ID corresponding to messages capable of being processed by the microcontroller 32;

(b) allocating (55) to each identifier code ID of the list an FMI index;

(c) associating (44) to each message having an identifier code of the list the FMI index that it has been allocated;

(d) associating (66) to each FMI index an address in the memory 64; and

(e) storing each message in the memory 64 at the address pointed by the FMI index.

The memories 48 and 50 have been described as registers, but can be implemented in the form of programmable and erasable memories, for instance, of the EEPROM (electrically erasable and programmable read-only memory) type. The number of registers for the desired size of memory 48, 50 is chosen to record the largest possible number of identifier codes and their associated index in order to adapt to evolutions in the applications of each node in terms of the number of identifier codes.

Table 66 can also be implemented with registers, but preferably by an EEPROM memory whose size is to be selected according to the same criteria as for memories 48, 50. The use of EEPROM type memories allow for an easy adaptation of the interface to the immediate needs of each node of the network, as well as future needs resulting from the evolution of each node in terms messages to be processed.

That which is claimed is:

1. Device for filtering to a microcontroller (32, MC) messages received in a node of a serial type communications network in which the messages are sent to all the nodes of the network and each comprises an identifier code indicating the content of the message, characterized in that it comprises:
means (50) for associating an index (FMI) to each identifier code (ID) from a list (48) of identifier codes corresponding to messages susceptible of being processed by the microcontroller (32, MC),
means (44, 46, 52) for associating, to each message corresponding to an identifier code of the list, the index (FMI) associated to that identifier code,
means (70) for storing in a FIFO type memory (54) the message received and its associated index (FMI), and
means (66) for associating to each index (FMI) an address in a memory (64) so as to store each message received at a determined address of the memory (64).

2. Device according to claim 1, characterized in that the means for associating an index (FMI) to each identifier code (ID) from a list (48) of identifier codes corresponding to messages susceptible of being processed by the microcontroller (32, MC) comprise a memory (48, 50) containing on the one hand the identifier codes of said list and on the other hand an index (FMI) for each identifier code of said list.

3. Device according to claim 1 or 2, characterized in that the memory containing the identifier codes (ID) of said list and the corresponding indexes (FMI) is a programmable memory.

4. Device according to claim 1, 2, or 3, characterized in that the means for associating, to each message corresponding to an identifier code of said list, the index (FMI) associated to that identifier code comprises:
a comparator (46) for comparing the identifier code of each message with each of the identifier codes of the list contained in the memory (48) and providing a signal when there is match,
a transfer circuit (52), controlled by said match signal, for associating to the received message the index (FMI) corresponding to recognized identifier code.

5. Device according to any one of claims 1 to 4, characterized in that the means for associating to each index (FMI) an address in a memory of the microcontroller (32, MC) comprise a programmable memory (66) which is addressable by the index (FMI).

6. Method of filtering to a microcontroller (32, MC) messages received in a node of a serial type communications network in which the messages are sent to all the nodes of the network and each comprises an identifier code indicating the content of the message, characterized in that it comprises the following steps consisting of:
(a) establishing a list (48) of the identifier codes (ID) corresponding to messages susceptible of being processed by the microcontroller (32, MC),
(b) allocating (55) to each identifier code (ID) of the list an index (FMI),
(c) associating (44), to each message presenting an identifier code of the list, the index (FMI) which has been allocated thereto,
(d) associating (66) to each index (FMI) an address in a memory (64), and
(e) storing each message in the memory (64) at the address pointed by the index (FMI) contained in the message.
